(19) United States
(12) Patent Application Publication
(10) Pub. No.: US 2003/0205433 A1
(43) Pub. Date: Nov. 6, 2003

(54) Variable straddle transporter lift with programmable height positions

(76) Inventor: Earl L Hagman, New Fairfield, CT (US)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(21) Appl. No.: 10/275,443

(22) PCT Filed: May 3, 2001
(86) PCT No.: PCT/US01/14313

(51) Int. Cl. B66F 9/20; B66F 9/06

(52) U.S. Cl. 187/223; 187/232; 187/231

(57) ABSTRACT

A transport lift (10) has a base (12) and two spaced-apart legs (30, 32) are slidingly mounted on the base for movement toward and away from each other. Wheels (34, 36, 38) support the base and legs for rolling movement. Leg motor drive means (62) operate to drive the two spaced-apart legs toward and away from each other to vary the straddle spacing between the legs. A lift column (14) extends generally vertically from the base. Lift drive means (16) are associated with the lift column for driving an end effectuator (18) along the lift column, the end of effectuator adapted for engaging a load. A programmable controller (90) operates the lift drive means to position the end effectuator at at least one predetermined height position on the lift column. The controller is adapted for storing a plurality of height adjustments as sequential steps, and the controller operates the lift drive means to place the end effectuator sequentially at the sequence of predetermined height positions.

### FIELD OF INVENTION

The invention herein relates to a variable-straddle transporter with power lift, the distance between the legs of the transporter being adjustable, and the power lift including programmed sequences of one or more predetermined height positions.

### BACKGROUND OF THE INVENTION

Transporters with power lifts are known and are also referred to as “transport lifts” herein. They generally comprise a base having spaced-apart legs, supported on wheels permitting the transport lift to be rolled throughout a work area. One or more lift columns extend generally vertically from the base, and mount and enclose a chain or screw lift drive. An end effectuator is attached to the lift drive, and the end effectuator may have a variety of configurations adapting it to engage, lift, and/or manipulate various load pieces.

One difficulty in using prior transporter lifts is in the placing of the legs and end effectuator relative to the load to be engaged and lifted. If the load is wide, the legs must straddle the load to engage the end effectuator under or through the load; however, the legs must also provide a width of the transport lift that permits passage through aisles and doorways.

Prior transport lifts have also been tedious and time consuming to use in placing or retrieving the lifted and transported load with respect to a shelf or other desired location. The typical sequence is to move the transport lift close to the destination, operate the lift drive to elevate the load above the desired location, then move the transport lift to position the load over the desired location, lower the load to rest at the desired location, and disengage the end effectuator. This sequence may consume considerable time in placing the load at its destination. Similarly, to retrieve the load, the end effectuator must be raised to the correct height for engaging the load, and many fine adjustments may be required to establish a height position for properly engaging the load.

Accordingly, improvement in these and other aspects of hand propelled transport lifts would be desirable.

### SUMMARY OF INVENTION

It is a principal object of the invention herein to provide an improved transporter with power lift.

It is another object of the invention to provide a transport lift with adjustable straddle legs.

It is a further object of the invention herein to provide a transport lift including programmable means for positioning an end effectuator at predetermined height positions with respect to a lift column thereof.

In carrying out the foregoing and other objects of the invention, there is provided a transport lift having a base and a lift column extending generally vertically from the base. Lift drive means extend along the lift column, including an end effectuator adapted for engaging a load. The end effectuator may also be capable of manipulating the load, if desired. Two spaced-apart legs are mounted to the base, each leg mounting a wheel adjacent its forward distal end, with the lift column and end effectuator positioned generally between the two spaced-apart legs. At least one of the two spaced-apart legs is slidably mounted on the base for movement away from and toward the other leg, providing variable straddle spacing between the legs.

According to other aspects of the invention, both legs are slidably mounted to the base, and are power driven toward and away from each other to adjust the straddle of the legs. The base mounts additional wheels rearwardly of the lift column and legs, to support the base and lift column and adapt the transport lift for rolling movement, which may be hand propelled.

In also carrying out the foregoing objects of the invention, the transport lift has a base supported on wheels for rolling movement. A lift column extends vertically from the base. Lift drive means extends along the lift column, including an end effectuator adapted for engaging and/or manipulating a load. The lift drive means further includes programmable controller means for positioning the end effectuator at one or more predetermined height positions on the lift column.

According to additional aspects of the invention, the lift drive means is a motor driven screw drive, and includes a counter providing input to the programmable controller means indicative of the height position of the end effectuator. The programmable controller means further includes a memory for storing data establishing a plurality of predetermined height positions of the end effectuator on the lift column, and a control panel for entering and recalling preprogrammed positions of the end effectuator on the lift column. The control panel is preferably a hand-held control pendant and connected for use a short distance from the lift column, to better observe its position and function, with buttons to operate the transport lift and its controller.

According to further aspects of the invention, the programmable controller means performs a sequence of programmed height positions of the end effectuator, incrementally in the order of programmed steps. The transporter lift is also operable in a manual mode.

Other and more specific objects and features of the invention will in part be apparent to those skilled in the art and will in part appear in the following detailed description, taken together with the drawings.

### BRIEF DESCRIPTION OF DRAWINGS

FIG. 1 is a perspective view of a transport lift according to the invention herein;

FIG. 2 is a top view of the transport lift of FIG. 1, with the legs adjusted to their narrow straddle position;

FIG. 3 is a top view of the transport lift of FIG. 1, with the legs adjusted to their wide straddle position;

FIG. 4 is a front view, partially cut away, of the transport lift of FIG. 1;

FIG. 5 is a bottom view, partially cut away, of the transport lift of FIG. 1;

FIG. 6 is another perspective view of the transport lift of FIG. 1;

FIG. 7 is a perspective view, partially cut away, of the lift column of the transport lift of FIG. 1, with an alternative end effectuator;

FIG. 8 is a perspective view, partially cut away, of the lift column of the transport lift of FIG. 1, with another alternative end effectuator;

FIG. 9 is a perspective view, partially cut away, of the lift column of the transport lift of FIG. 1, with another alternative end effectuator;

FIG. 10 is a schematic diagram of a programmable controller, control pendant, motor and counter of the transport lift of FIG. 1; and

FIG. 11 is a schematic diagram, comprised of FIG. 11A and 11B assembled as shown, of the operator interaction with the transport lift of FIG. 1, for programming and operating the transport lift.

The same reference numerals refer to the same elements throughout the various Figures.

### DETAILED DESCRIPTION OF PREFERRED EMBODIMENT

A transport lift 10 according to the invention generally comprises a base 12 and a lift column 14 extending generally vertically from the base 12. The lift column 14 includes lift drive means generally indicated at 16, for raising and lowering an end effectuator 18 adapted to engage a load.

The end effectuator 18 has two spread-apart lift-bars 18a and 18b which can be positioned under a pallet. A plurality of configurations of end effectuators 20, 21 and 22 are illustrated in FIGS. 7, 8, and 9, respectively, for engaging and manipulating variously configured loads 23, 24 and 25. In FIG. 7, end effectuator 20 is C-shaped, for engaging the lip of a bucket or drum 23. FIG. 8 shows end effectuator 21 in the form of a rod, for insertion in the mandrel of a roll 24. In FIG. 9, end effectuator 22 is a platform with a turntable supporting load 25, so that the load may be swivelled.

The transport lift 10 is adapted for rolling movement throughout a plant or other work area by legs 30 and 32 extending forwardly of the base 12, the legs 30 and 32 respectively provided with wheels 34 and 36 at their forward distal ends. The base 12 is further supported on wheels 38 and 40, positioned rearwardly of the lift column 14 and mounted on vertical axles so that they may turn to provide directional maneuverability of the transport lift 10. A handle 42, position adjustable for height and tilt, is mounted to the lift column 14 and provides an operator with a suitable convenient grip for positioning and hand propelling the transport lift 10.

It will be appreciated that the end effectuator 18 is driven up and down the lift column 14 by the lift drive means 16. For instance, the end effectuator 18 can be positioned adjacent the floor in its lowermost position to pick up a load, and may lift the load to an elevated position adjacent the lift column 14, as further discussed below.

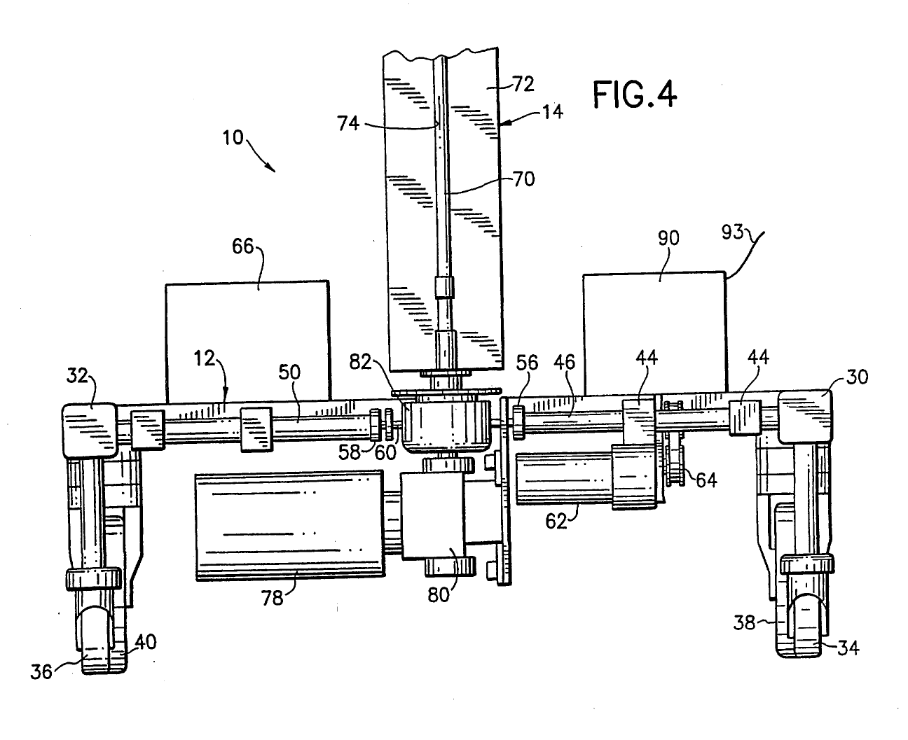

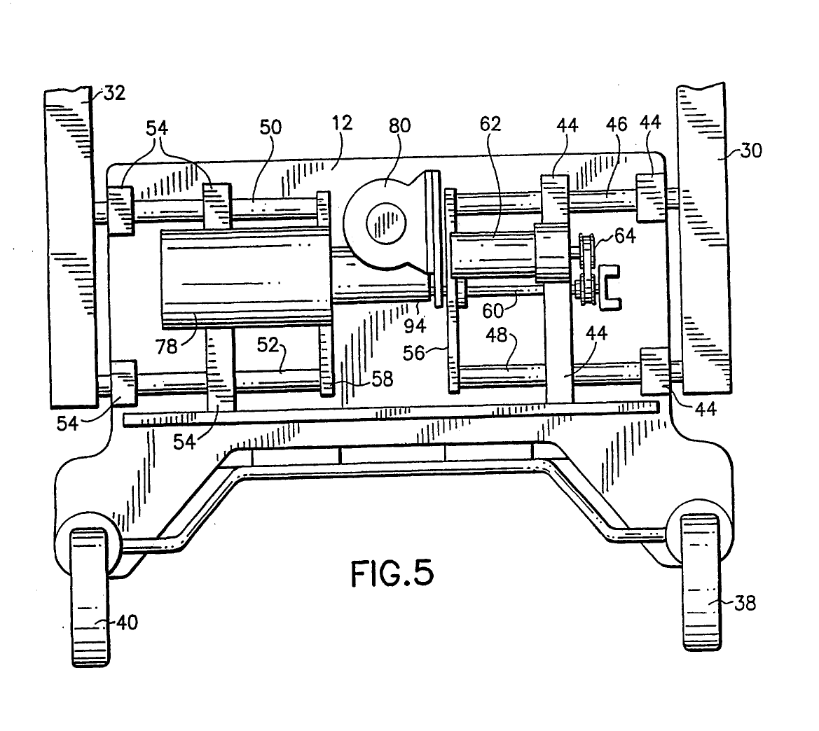

The legs 30 and 32 are laterally slidably mounted on the base 12, providing for a variable straddle T of the transporter 10. With reference to FIGS. 4 and 5, the base 12 includes a first plurality of bearings 44 which slidingly receive shafts 46 and 48, to which leg 30 is mounted. Similarly, leg 32 is mounted on two shafts 50 and 52, which are slidingly received in a plurality of bearings 54. Shafts 46 and 48 are connected by a drive bar 56, and the shafts 50 and 52 are also connected by a drive bar 58. Drive bars 56 and 58 are engaged by a threaded drive shaft 60 which is powered by a reversible leg straddle drive motor 62 through a drive linkage generally indicated at 64. A battery provides power for the motor 62 and other electrical components of the transport lift 10.

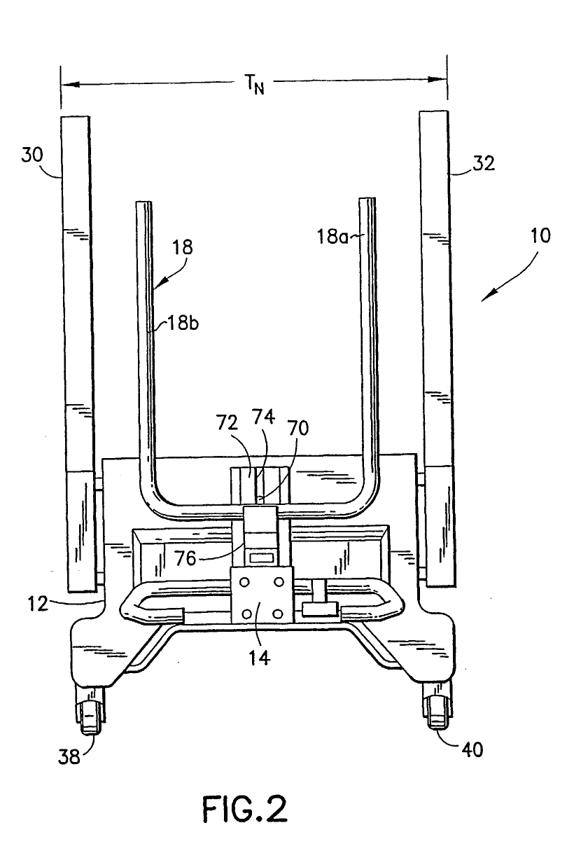

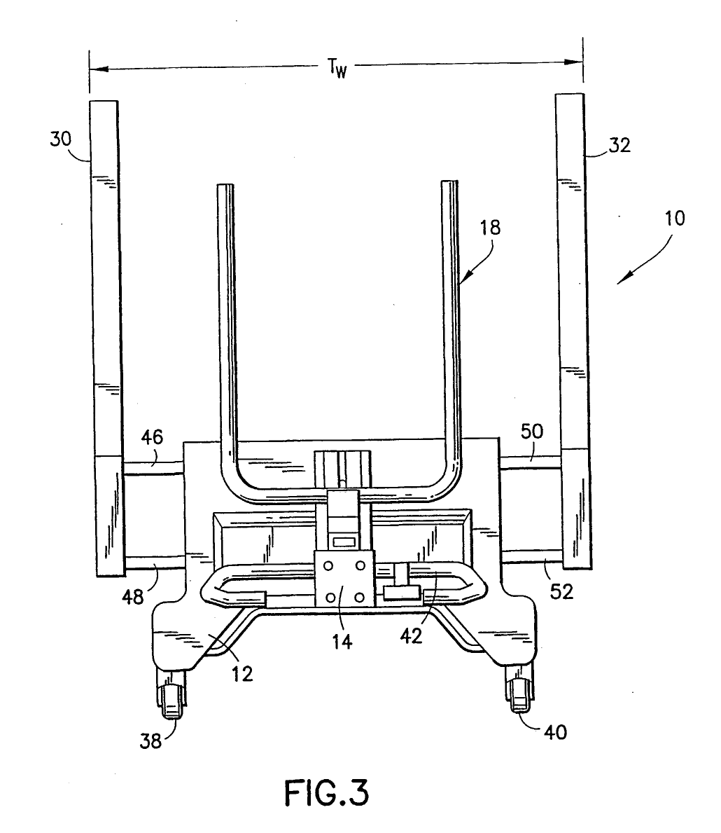

With reference to FIG. 2, the motor 62 may be operated to move the legs 30 and 32 toward each other, to an inward position where the transport lift 10 has its narrowest straddle or track, namely track T_{N}. In the preferred embodiment shown, this narrow straddle is preferably about 22 inches, which adapts the transport lift 10 for passage through narrow aisles and doorways. With reference to FIG. 3, the drive motor may be operated to move the legs 30 and 32 away from each other, establishing a maximum width straddle or track T_{W} which, in the embodiment shown, is preferably about 37 inches. These straddle dimensions provide a useful transporter lift 10, but other straddle dimensions may be provided, as required for different applications.

It will be appreciated that the wider straddle T_{W} accommodates wider and higher loads, such as pallets, between the legs 30 and 32 for pick up by the end effectuator 18. Additionally, the wider straddle T_{W} provides additional stability and may be used during rolling transport except when a narrower straddle is required for clearance in tight spaces.

The transport lift 10 is generally utilized to lift and place a load at an elevated location, or to remove a load from an elevated location and place it on a floor or other lower surface, or otherwise transport and height-position a load. The lift column 14 provides support for the load, and the lift drive means 16 is used to lift the load. In the embodiment shown, the lift drive means 16 includes a threaded drive screw 70 mounted in a lift column housing 72, the housing 72 defining a slot 74. A mounting carriage 76 is threadably engaged on the drive screw 70 and accordingly moves up and down in response to rotation of the drive screw 70. The mounting carriage 76 provides for mounting a variety of end effectuators, such as the end effectuator 18 or the end effectuators 20, 21 and 22 shown in FIGS. 7, 8 and 9 and discussed above. A chain drive system may be used instead of a screw drive.

With continued reference to FIGS. 4 and 5, the base 12 mounts a screw drive motor 78 that powers a gear box 80, which transmits power from the motor to the drive screw 70. A brake 82 is provided between the gear box and the drive screw, and operates to lock the drive screw 70 when the motor 78 is not in operation, so that a heavy load does not act to reverse the drive screw and thereby lower the load from its intended position.

It will be appreciated that in many instances the transport lift 10 will perform repetitive lifting functions. For example, it may be used to remove a load from a delivery area and to position it on a shelf in a storage area where the height of the shelf is a constant. In such movements, it may be desired to move the load to an intermediate height during transport. The transport lift may also be used to remove a load from a storage area at a first height and place the load in a work area at a second height, again with the possibility of an intermediate height during transit between areas. With prior art transporters, the operator would be required to manually adjust the height of the transporter to engage and lift the load, to manually adjust the height again while moving the transporter to the next station, and then to manually adjust the height load to an appropriate height for depositing it at the next area. Each of these manual adjustments are time consuming and if not performed correctly, risk damage to the load, storage area or work station.

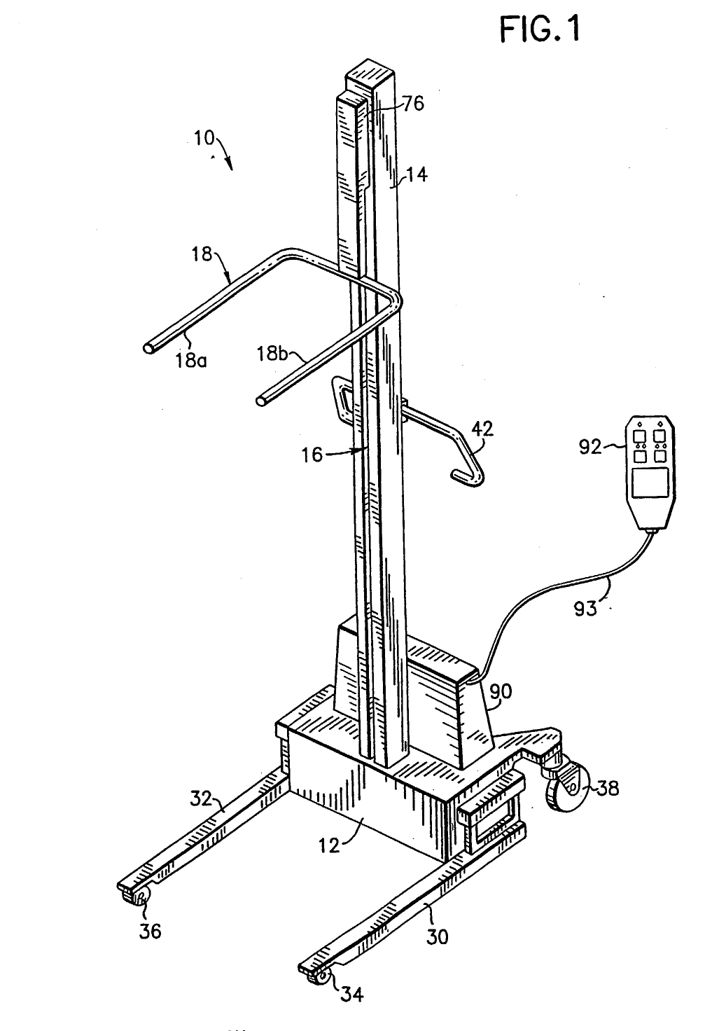

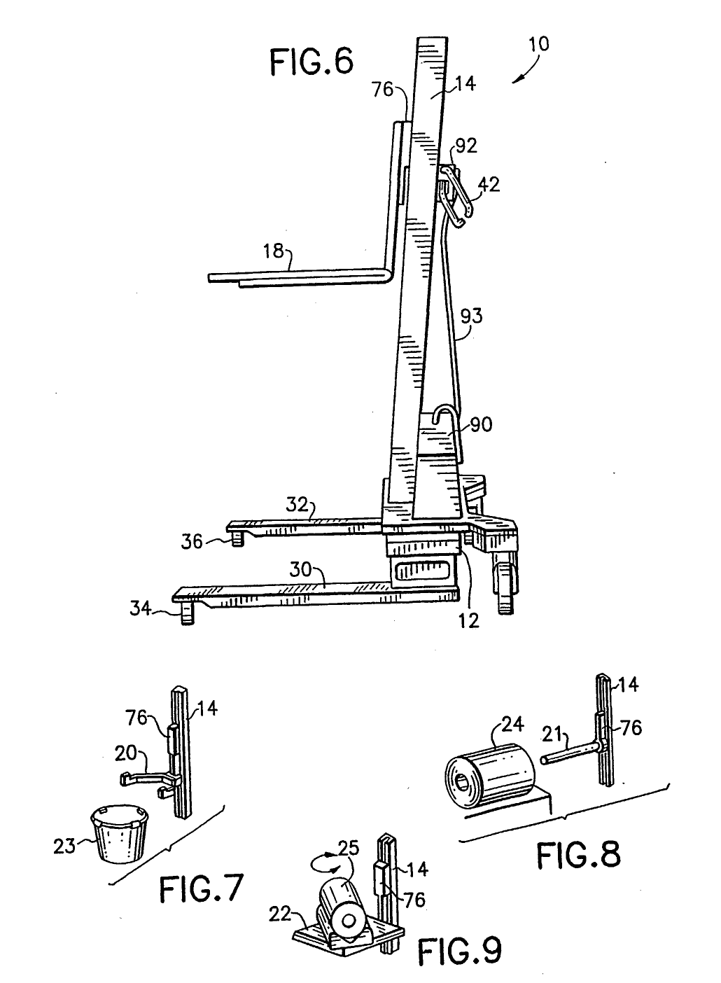

The transport lift 10 includes a programmable controller 90 having a control panel provided on a handheld control pendant 92, the control pendant 92 being utilized to operate the variable straddle legs 30, 32, to manually operate the lift drive means 16, to program height position steps in the controller, and to perform those steps. With reference to FIG. 6, the controller 90 is mounted on base 12 and the control pendant 92 is removably mounted on the handle 42, being connected to the controller by cord 93. In FIG. 1, the pendant 92 is shown removed and spaced from the handle, which permits the operator to better see the load and destination as the operator makes height adjustments. The control pendant has a display 96, which is alternatively mounted on the handle 42 or other convenient location.

The control pendant 92 and controller 90 also provide a means for storing in memory certain height positions of the lift drive means 16 and then repeatably positioning the lift drive means at those height positions without manual adjustment. The height positions are determined by a counter 94 which counts the rotations of the motor 78 or drive screw 70 driven thereby, the drive screw 70 being positively connected to the mounting carriage 76 and end effectuator 18. The operator can implement one of the height positions by means of the controller and activate the lift drive means 16 to elevate the load to the desired height position while the transport lift 10 is in transit and approaching the location. Thus, when the transport lift 10 arrives at the location, the load is prepositioned for deposit at the desired height, without need of further fine manual adjustment. In the preferred transport lift 10, the height positions of the lift drive means are performed as sequential steps, so that the user can make the next height adjustment by depressing a single button on the control pendant 92. Provision is made for programming by means of the control pendant 92.

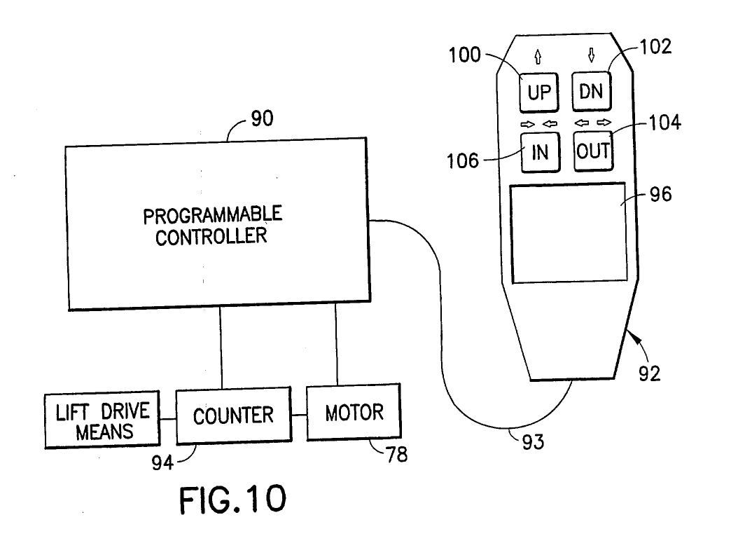

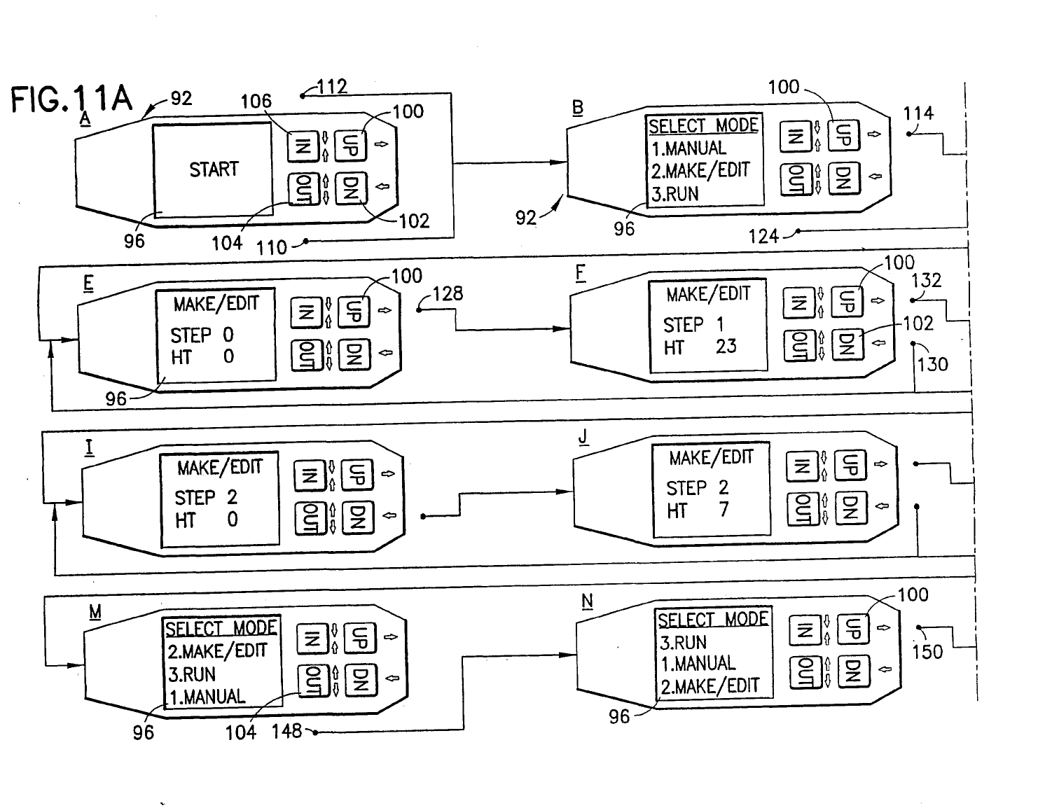

With reference to FIG. 10, the programmable controller 90 is connected to operate the motor 78 of the lift drive means 16, and the motor drives the counter 94 with the drive screw 70 in order to provide feedback to the controller as to the number of turns of the drive screw 70 of the lift drive means 16. The provides the programmable controller with sufficient information to ascertain the height of the end effectuator of lift drive means 16.

FIG. 10 also illustrates the control pendant 92, which is provided with a display screen 96, which may also be mounted on the handle 42 or lift column, and four control buttons; namely, an “up” button 100, a “down” button 102, an “out” button 104 and an “in” button 106. The programmable controller 90 operates in one of three modes; namely, a Manual mode, in which the height of the lift mechanism and the straddle of the legs 30 and 32 are determined directly by the four control buttons 100, 102, 104 and 106; a Make/Edit program mode, in which numbered sequential steps each consisting of an adjusted height position of the lift drive means are established; and a Run mode, in which the programmable controller sequentially performs the steps of predetermined height adjustments.

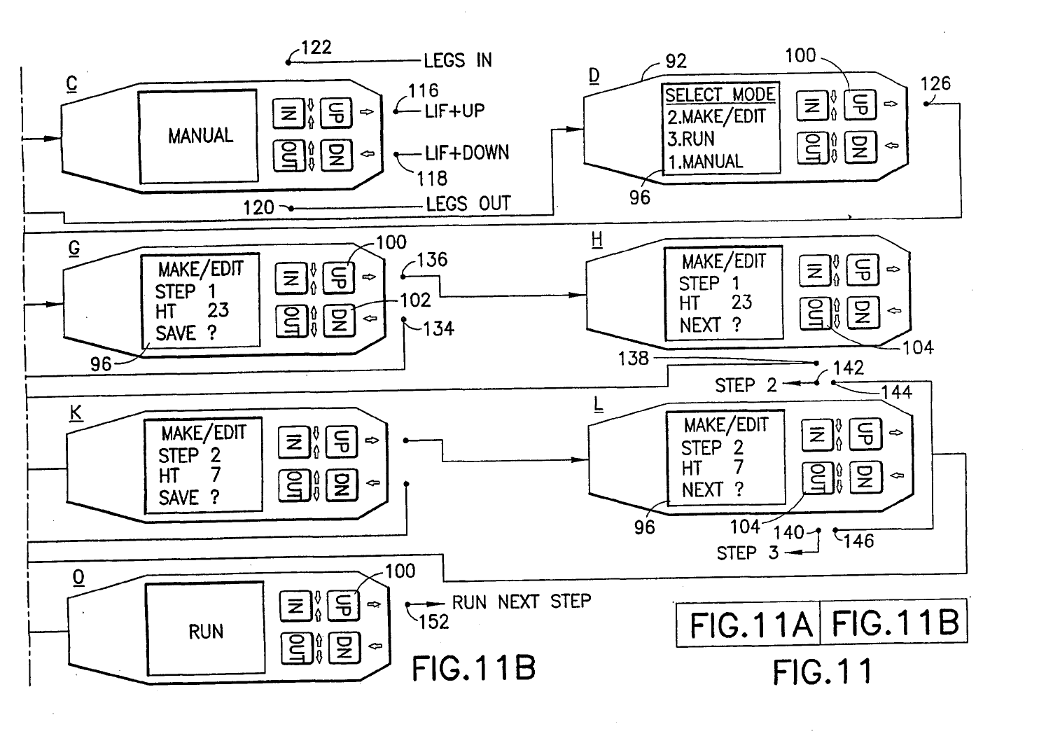

FIG. 11 is a schematic diagram showing how the control panel pendant 92 is utilized to operate the transport lift 10 in the Manual mode, to store a sequence of selected position in the Make/Edit program mode, and to operate the transport lift in the Run mode. The controller 90 is pre-programmed to carry out the functions described below.

With further reference to FIG. 11, the control pendant 92 is shown at A in a start condition, wherein “start” may be displayed on the screen 96. Simultaneously depressing the “out” button 104, as indicated at 110, and the “in” button 106, as indicated at 112, for a short period of time, which may be approximately 3 seconds, causes the controller 90 to enter a “Select Mode” condition illustrated at B of FIG. 11.

In the “Select Mode” condition, a menu appears on the display screen allowing mode selection as follows:

Mode

1. Manual

2. Make/Edit

3. Run

In the “Select Mode” condition, and in other conditions to be described below, the four buttons 100, 102, 104 and 106 respectively and generally take on the following functions:

Up=select

Down reset

Out scroll forward

In=scroll back

When the controller 90 is in the condition B of FIG. 11, the “Manual” mode is in the uppermost menu position on the screen 96 and may be selected by pressing the up=select button 100, as indicated at 114. This places the controller and pendant in the Manual mode of operation, shown in C of FIG. 11.

In the Manual mode, the four buttons on the control pendant 92 have the following functions:

Up button 100—The motor 78 is operated for the period of time the up button 100 is depressed, as indicated at 116, with the motor elevating the mounting carriage 76 and end effectuator 18. The motor stops when the button 100 is released or when the mounting carriage reaches its full extent of travel;

Down button 102—While the down button 102 is depressed, as indicated at 18, the motor 78 is operated to lower the mounting carriage 76 and end effectuator 18. The motor continues to operate until the down button 102 is released, or until the mounting carriage reaches its lowest extent of travel;

Out button 102—The motor 62 operates while the out button 102 is depressed, as indicated at 120, to increase the straddle between legs 30 and 32, until the button 102 is released or until the maximum straddle is achieved; and

In button 104—The motor 62 operates while the in button 106 is depressed, as indicated at 122, to decrease the straddle of the legs 30, 32, until the in button 104 is released or until the minimum straddle is achieved.

With reference condition B of FIG. 11, if the out button 104 is depressed, as indicated at 124, instead of the up button 100, the Mode Select display will scroll forward to the next mode, which is the Make/Edit mode illustrated as condition D. If the operator wishes to make or edit the program, the operator presses the up button 100 as indicated at 126 causing the controller 90 and control pendant 92 to select Make/Edit and enter the condition illustrated at E of FIG. 11.

The beginning of the Make/Edit process is shown in condition E, with the screen 96 reading: “step-0: height-0”. Depressing the up button 100, as indicated at 128, raises the mounting carriage 76 and end effectuator 18 until the button 100 is released with the end effectuator 18 at a desired adjusted height position. Alternatively, depressing the down button 102 would lower the mounting carriage 76 and end effectuator 18 to a desired adjusted height position. When the up button 100 or down button 102 is released, the controller 90 and control pendent 92 advance to the condition F, next illustrated in FIG. 11.

In condition F, the selected height position is displayed for program step 1. If the operator is not satisfied with the height position, the operator presses the down button 102, as indicated at 130, which returns the controller 90 and control pendant 92 to condition E, so that the height position can be reselected in the same manner described above. However, if the operator is satisfied with the adjusted height position, the operator presses the up button 100, as indicated at 132 to select the height position and the controller and pendant progress to condition G.

In condition G, the step number and adjusted height position are again displayed on the panel 96, together with a prompt “save?”. The operator has the choice of pressing the down button 102, as indicated at 134, which cancels the adjusted height position and returns the controller to condition E for re-entering the program step, or depressing the up button 100, as indicated at 136, which saves the height position and advances the controller and control pendant to the condition H, where the step number and height position are displayed. From condition H, the operator will generally scroll forward to program step 2 beginning with condition I. The scroll forward is achieved by pressing out button 104, as indicated at 138. The operator may also exit the Make/Edit mode by simultaneously depressing out button 104 and in button 106.

Condition I of the controller and control pendant is similar to the of condition E, except that condition I is utilized for setting the adjusted height position for the next step in he program sequence. Thus, the adjusted height position for the step 2 of the program sequence is created in the positions I, J, K and L, in the same way that the height position for step 1 of the program was created in positions E, F, G and H described above.

In completing the entry of program step 2, the controller and control pendant enter the condition L of FIG. 11. The operator has three options. First, the operator can press the out button 104, as indicated at 140, and the controller and control pendant will scroll forward, or advance, to a condition like those illustrated at E and I for programming step 3 in the program sequence. This choice can be repeated after each step until all steps are programmed. Second, the operator can press the in button 106, as indicated at 142, and the controller 90 and control pendant 92 will sequentially scroll back through previous program steps for possible alteration thereof. Third, the operator can simultaneously depress the out button 104 and the in button 106, as indicated at 144 and 146, causing the controller and control pendant to re-enter the Select Mode condition illustrated at M.

Condition M differs from Select Mode condition B in that Make/Edit the select position, and unless the operator desires to re-enter the Make/Edit mode, the operator would press the out button 104, as indicated at 148, to scroll the menu forward and place Run in the upper or selection position, as indicated at condition N. The operator may then press the up button 100, as indicated at 150, to place the controller and control pendant in the Run mode, illustrated as condition O.

In the Run mode, the operator presses the up button 100, as indicated at 152, and the controller will operate the motor 78 to place the mounting carriage 76 and end effectuator 18 in the height position set in program step 1. When the operator presses the up button 100 again, the controller operates the motor 78 to place the mounting carriage 76 and end effectuator 18 in the height position established as step 2. Sequential pressing of the up button 100 causes the controller to sequentially execute height positions of the numbered steps established in the Make/Edit mode, recycling to step 1 after the final step has been accomplished.

Therefore, the operator may establish a sequence of desired height positions of the end effectuator, and then perform the selected height positions by placing controller in the Run mode and sequentially depressing the up button 100. The mounting carriage and end effectuator attached thereto automatically go directly to the desired adjusted height position, without any fine tuning by the operator, permitting the operator to place and retrieve loads in a highly efficient and simple manner.

It should be noted that if one step of-the program requires adjustment, the operator can enter the Make/Edit mode when the transport lift is at the location where a change is needed. The current program step will appear on the display screen, and the height position for that step can be re-established as desired. The operator may then return to the Run mode, or can scroll to another program step for adjustment before returning to the Run mode.

Of course, the Run mode and the Manual mode are independently available, with the Manual mode being more useful for jobs without an established sequence. The straddle of the legs is controlled by the operator independently of the program, based on the operator's judgement as the operator propels the transport lift through the work area.

The foregoing programming sequences represent a preferred embodiment but other programming sequences are within the purview of this disclosure. The important aspects are establishing a plurality of preselected height positions, and providing for executing them in a desired sequence, in order to increase the ease and efficiency of using a transport lift.

The transport lift 10 described above admirably achieves the objects of the invention herein. It will be appreciated that the transport lift 10 is illustrative of the invention, and that various changes may be made without departing from the spirit and scope of the invention, which is limited only by the following claims.

1. A transport lift comprising:
A) a base having at least one wheel supporting the base for rolling movement;
B) a lift column extending generally vertically from the base;
C) lift drive means associated with the lift column for driving an end effector along the lift column, the end effectuator adapted for engaging a load; and
D) two spaced-apart legs mounted to the base, each leg mounting a wheel near the forward distal end thereof, at least one of the two spaced-apart legs slidingly mounted on the base for movement toward and away from the other leg, providing for variable straddle spacing between the legs.

2. A transport lift as defined in claim 1 wherein both of the two spaced-apart legs are slidingly mounted on the base for movement toward and away from and toward each other.

3. A transport lift as defined in claim 2 and further comprising:
E) leg motor drive means operable to drive the two spaced-apart legs toward and away from each other to vary the straddle spacing between the legs.

4. A transport lift as defined in claim 3 wherein the base mounts at least two spaced-apart wheels, the wheels of said legs and the at least one wheel of said base supporting the transport lift for rolling movement.

5. A transport lift as defined in claim 3 and further comprising manually operable control means for operating the leg motor drive means.

6. A transport lift as defined in claim 5 and further comprising a handle mounted to the lift column for propelling the transport lift in rolling movement, the manually operable control means being positioned on said handle.

7. A transport lift as defined in claim 3 wherein the lift column is positioned between the two spaced-apart legs.

8. A transport lift as defined in claim 7 wherein the lift column is generally centrally positioned between the two spaced-apart legs, including as the leg motor drive means is operated to drive the legs toward and away from each other.

9. A transport lift as defined in claim 1 and further comprising:
E) leg motor drive means operable to drive the at least one of the two spaced-apart legs slidingly mounted on the base toward and away from the other leg.

10. A transport lift comprising:
A) a base supported on wheels for rolling movement;
B) a lift column extending generally vertically from said base;
C) lift drive means associated with the lift column and including an end effectuator adapted for engaging a load, said lift drive means operable to raise the end effectuator and a load carried thereby to height positions on the lift column; and
D) a programmable controller for operating the lift drive means to position the end effectuator at at least one predetermined height position on the lift column.

11. A transport lift as defined in claim 10 wherein the lift drive means includes a lift drive motor and further comprising a counter for counting rotation of the lift drive motor or elements of the lift drive means driven by the lift drive motor, said counter providing input to the controller indicative of the movement and position of the end effectuator.

12. A transport lift as defined in claim 11, wherein the lift drive means comprises a drive screw extending along the lift column and a mounting carriage threadably engaged with the drive screw for movement along the lift column upon rotation of the drive screw, said end effectuator being secured to the mounting carriage.

13. A transport lift as defined in claim 12 wherein the counter counts rotations of the drive screw, said counter providing an input to the programmable controller means that is indicative of the height position of the mounting carriage and end effectuator on the lift column.

14. A transport lift as defined in claim 8 including a brake forming a portion of the lift drive means, said brake securing the lift drive means at adjusted height positions between periods of operation of the lift drive means.

15. A transport lift as defined in claim 10 and further comprising:
E) two spaced-apart legs slidingly mounted to the base for movement toward and away from each other, said legs having wheels for rolling movement with the base; and
F) leg motor drive means operable to drive the two spaced-apart legs toward and away from each other, thereby providing variable straddle spacing between the legs.

16. A transport lift as defined in claim 10 wherein the controller stores a plurality of predetermined height positions of said end effectuator and is operable to place the end effectuator at a selected one of said predetermined height positions.

17. A transport lift as defined in claim 16 wherein the controller is operable place the end effectuator sequentially at a sequential plurality of predetermined height positions.

18. A transport lift as defined in claim 16, wherein the programmable controller includes a control panel for entering and recalling predetermined height positions of the end effectuator.

19. A transport lift as defined in claim 18 wherein the control panel is a hand-held control pendant communicating with the controller.

20. A transport lift as defined in claim 18 wherein the control panel has four control buttons.

21. A transport lift as defined in claim 20 wherein the controller has a Make/Edit program mode for establishing and revising predetermined height positions of the end effectuator, in which two of the four buttons provide up and down commands to move the end effectuator to a height position and the four buttons also provide a save function to save a selected height position, a reset function to re-establish a height position, a scroll forward function to access the next sequential height position, and a scroll back function to return to the previous sequential height position.

22. A transport lift as defined in claim 21 wherein the programmable controller further comprises a display screen that displays the sequential step and the predetermined height position for the sequential step.

23. A transport lift as defined in claim 18 wherein the programmable controller has a Run mode in which pressing a control button associated with the control panel operates the lift drive means to place the end effectuator at the next sequential predetermined height position.

24. A transport lift-as defined in claim 20 wherein the programmable controller has a Manual mode in which two of the control buttons respectively provide up and down operation of the lift drive means.

25. A transport lift as defined in claim 24 and further comprising:
E) two spaced-apart legs slidingly mounted to the base for movement toward and away from each other, said legs having wheels for rolling movement with the base; and
F) leg motor drive means operable to drive the two spaced-apart legs toward and away from each other to provide variable straddle spacing between the legs;
wherein the other two buttons of the control panel respectively provide toward and away from operation of the leg motor drive means.
